(19) United States
(12) Patent Application Publication
(10) Pub. No.: US 2005/0264543 A1
(43) Pub. Date: Dec. 1, 2005

(54) Video Backpack and Garment System and Method Of Using the Same

(76) Inventor: Ignaz M. Gorischek, Dallas, TX (US)

Correspondence Address: CHRISTIE, PARKER & HALE, LLP, PO BOX 7068, PASADENA, CA, 91109-7068, US

(21) Appl. No.: 10/833,564

(22) Filed: Apr. 28, 2004

(51) Int. Cl. G09G 5/00

(52) U.S. Cl. 345/204

(57) ABSTRACT

An image display system is provided, comprising a wearable gear, such as a backpack or garment, with an integrated electronic display screen, at least one video image source capable of providing an image on the display screen, and a control unit. The control unit controls the video image source to transmit to the display screen signals that are representative of the image. The backpack and garment may be used as functional items for entertaining, informing, or educating a viewer via images displayed on the display screen. The backpack and garment may also be used as novelty items by controlling the images displayed on the display screen and changing the appearance of the backpack and garment. The backpack and garment may further act as a marketeering tool for displaying advertisement messages.

### BACKGROUND OF THE INVENTION

Backpacks and knapsacks (collectively referred to as backpacks) provide a convenient way for transporting objects from one location to another. Backpacks are popular because they allow items to be conveniently carried on the back of a person while freeing-up the person's arms and hands. Thus, backpacks, unlike other cases, valises or luggage, generally allow the wearers of the backpack to infiltrate and maneuver themselves in a crowd without much added hinderance.

Many people use backpacks to transport everyday items such as books, clothing, and sporting gear. Backpacks also provide a convenient way to transport electronic equipment such as digital versatile disc (DVD) players, laptops, cameras, personal digital assistants (PDAs), and the like. Having these types of equipment near a traveler during a trip is highly desirable if not necessary for the traveler's entertainment and/or convenience. However, if a person desires to take any of these devices on a trip, he or she needs to ensure that they are indeed packed in the backpack or in a separate case lest they be forgotten and left behind. There is a desire, therefore, to be able to integrate one or more of these electronic devices into the backpack itself, and help free a traveler from having to separately pack them in preparation for a trip.

In addition to using backpacks for transporting items, backpacks are often used as an accessory to complement one's outfit, or to represent a wearer's particular style or mood. Backpacks may further be decorated with decorative pins, buttons, and the like, to help make a personal statement and capture other people's attention. It is desirable, therefore, to allow the backpack to be at least partially modified to display and convey different images, pictures, and messages. Such images may provide entertainment to the wearer of the backpack as well as to others viewing the backpack.

### SUMMARY OF THE INVENTION

According to one embodiment, the present invention is directed to an image display system that includes a wearable gear, such as a backpack or garment, having an integrated electronic display screen. The system also includes at least one video image source capable of providing an image on the display screen, and a control unit. The control unit is coupled to the video image source and is configured to control the video image source to transmit to the display screen signals that are representative of the image.

According to another embodiment, the present invention is directed to a portable bag that includes a body contact side, a non-body contact side, at least one video image source, and a control unit. The body contact side includes at least one shoulder strap that is adapted to be hung from a user's shoulder. The non-body contact side includes an opening for receiving an electronic display screen. The control unit is coupled to the video image source and the display screen, and is configured to control the video image source to transmit to the display screen signals that are representative of the image.

According to a further embodiment, the present invention is directed to a garment that includes a front portion, back portion, and shoulder portion. The front portion rests against the wearer's chest while the back portion rests against the wearer's back. The shoulder portion rests on the wearer's shoulders. An opening on the front and/or back portion receives an electronic display screen. The garment also includes a video image source and a control unit. The control unit is coupled to the video image source and the display screen, and is configured to control the video image source to transmit to the display screen signals that are representative of the image.

Many uses of such a portable bag and garment are contemplated according to various embodiments of the invention. According to one embodiment, the portable bag and garment may be used as a functional item for entertaining, informing, or educating a viewer of the backpack via images displayed on the image display device. The images may be provided by a camera or a video disc reader such as, for example, a DVD or VCR reader.

According to another embodiment, the portable bag and garment may be used as a novelty item by controlling the images displayed on the display screen and changing the appearance of the bag and/or garment.

According to a further embodiment, the portable bag and garment may act as a marketeering tool to display advertisement messages on the display screen.

The present invention is also directed to a method for displaying images that utilizes a wearable gear having an integrated electronic display screen. The display screen is coupled to a control unit that communicates with a video image source. The method includes receiving from the video image source signals representative of a first image, and displaying the image on the display screen.

According to yet another embodiment, the present invention is directed to a method for advertising that utilizes a portable bag or garment having an integrated electronic display screen. The display screen is coupled to a control unit that communicates with a video image source. The method includes receiving from the video image source signals representative of an advertisement message, and displaying the advertisement message on the integrated electronic display screen. The method further includes transporting the portable bag or wearing the garment so as to allow the display screen to be viewable by someone other than the user of the bag or garment.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

In the drawings, which constitute part of this specification, exemplary embodiments demonstrating various features of the invention are set forth as follows:

FIG. 1 is a perspective view of a video backpack system according to one embodiment of the invention;

FIG. 2A is an exploded perspective view of the backpack of FIG. 1 according to one embodiment of the invention;

FIG. 2B is an exploded perspective view of the backpack of FIG. 1 according to another embodiment of the invention;

FIG. 3 is a block electrical circuit diagram of the video backpack system of FIG. 1 according to one embodiment of the invention;

FIGS. 4A-4B illustrate a garment with an integrated electronic device according to one embodiment of the invention;

FIGS. 5A-5B illustrate an alternative garment with an integrated electronic device according to another embodiment of the invention.

### DETAILED DESCRIPTION

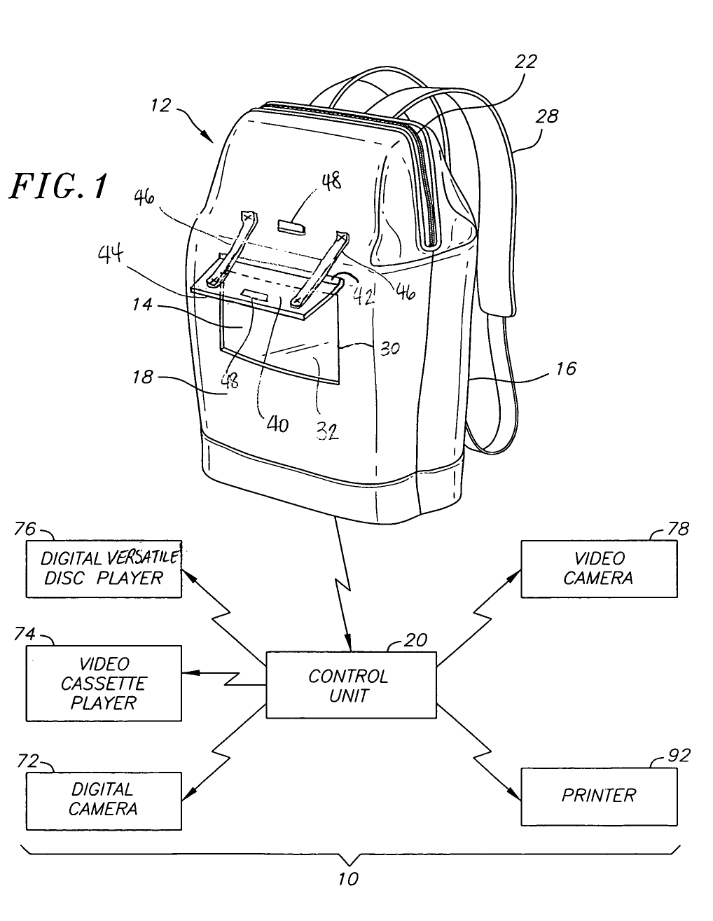

FIG. 1 is a perspective view of a video backpack system 10 according to one embodiment of the invention. The system 10 includes a backpack 12, an image display device 14, a microprocessor-based control unit 20, and one or more of various image sources such as, for example, a digital camera 72, video cassette reader 74, digital versatile disc (DVD) reader 76, video camera 78, and the like. The system may further include a printer 92 for printing an image displayed on the image display device 14.

According to one embodiment of the invention, the video backpack system 10 is composed of merely the backpack 12, image display device 14, control unit 20, and DVD reader 76. According to this embodiment, the image display device 14, control unit 20, and DVD reader 76 are housed within a single device that is integrated into the backpack.

For use with the integrated backpack and the image display device 14, one or more of the various image sources 72-78, and/or printer 92, which may be remote from or outside of the backpack or integrated therewith, are coupled to the microprocessor based control unit 20 operating under firmware or software program control for performing any needed processing functions and for controlling operation of one or more of the devices to which it is coupled. A user input device 91 such as, for example, a keypad, keyboard, or remote controller may also be provided for interacting with the control unit 20 and controlling the image display device 14, one or more of the various image sources 72-78, and/or printer 92.

According to one embodiment of the invention, the backpack 12 includes a body-contacting back panel 16, non- body-contacting front panel 18, top portion 22, and bottom portion 24. An opening across the top portion 22 of the backpack 12 allows access to the backpack's interior. The opening may be secured by a zipper or other fastening mechanism known in the art.

The back panel 16 includes shoulder straps 26, 28 to allow a user to carry the backpack on his or her shoulders. In this regard, the user places his or her arms through the shoulder straps 26, 28 and supports the backpack in place against the user's back with the front panel 18 exposed for viewing.

The front panel 18 includes an integrated electronic image display device 14 occupying a center portion of the front panel. A person of skill in the art should recognize that the image display device 14 may occupy any other portion of the backpack 12, and may be larger or smaller than what is illustrated in FIG. 1. The image display device 14, however, should be of a suitable size and weight so as to allow the backpack to be carried by the user on his or her shoulders.

According to one embodiment of the invention, the image display device 14 should also be of a suitable size and weight so as to allow the backpack to remain in a relatively upright position when placed on a table, stand, or another relatively flat surface. The backpack 12, according to this embodiment, may be constructed using frame and materials that are sufficiently rigid to allow the backpack to sustain the weight of the video display device 14 and remain in the relatively upright position when placed on the surface. The bottom portion 24 of the backpack may also include support pegs (not shown) to support the backpack in the relatively upright position. It is understood, however, that the backpack is not limited for use in the upright position, but can also operate, for example, in a reclined position, so long as the image display devices 14 is viewable.

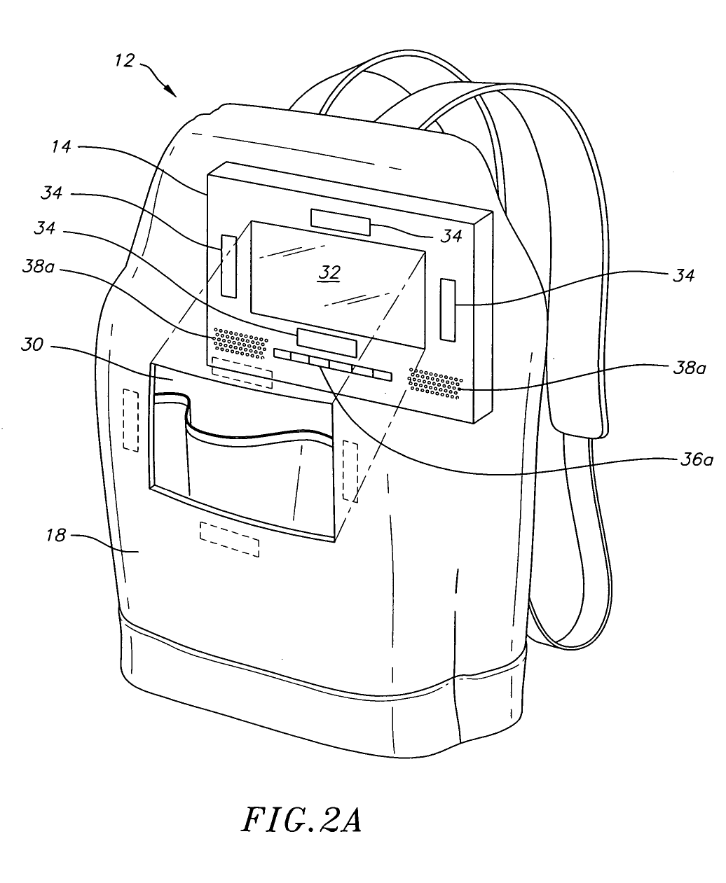

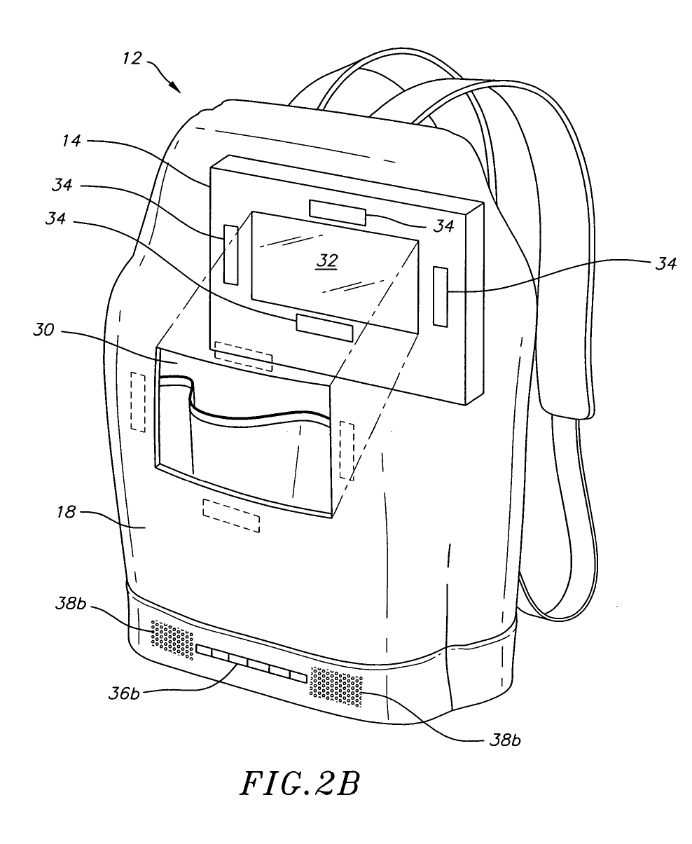

Referring now to FIGS. 2A-2B, the front panel 18 of the backpack is configured with an opening 30 which receives a display screen 32 of the image display device 14. The image display device 14 is in turn configured with Velcro® tabs 34 or other types of fasteners around the border of the image display device 14 for mounting the image display device onto the opening 30. The types of fasteners that are selected may depend on whether the display device 14 is to be permanently or temporarily affixed to the backpack.

Also included around the border of the image display device 14 are control buttons 36 that may be manipulated by the user for controlling the image display device, one or more of the various image sources 72-78, and/or the printer 92. The border of the image display device 14 may also include audio speakers 38 connected and configured within the system to transmit to the user (or any other intended recipient) any audio component from the video image sources.

According to one embodiment of the invention, the control buttons 36 and audio speakers 38 may be incorporated into other portions of the backpack 12. As illustrated in FIG. 2B, the control buttons 36 and audio speakers 38 may be incorporated into the bottom portion 24 of the backpack. The functionality of the control buttons 36 may also be provided by the user input device 91.

According to one embodiment of the invention, the display screen 32 may take the form of a liquid-crystal-display. (LCD) screen, plasma screen, or any other suitable display apparatus conventional in the art. Pressure sensitive (touch screen) technology may be incorporated into the display screen 32 in addition or in lieu of the control buttons 36 and/or user input device 91, so that the user may control one or more of the various image sources or printer by merely touching certain portions of the screen.

As shown in FIG. 1, a shade panel 40 may be provided to shade the display screen 32 when the backpack 12 is used in an outdoor setting or an otherwise illuminated environment. The panel 40 is affixed along its lower edge 42 to the front panel 18 of backpack 12 above the opening 30, while its upper edge 44 is attached to ends of straps 46 whose other ends are affixed to the front panel 18. The shade panel 40 is deployed when it is allowed to fall away from the front panel. To that end, the straps 46 have a length that enables the panel 40 to recline to a nearly horizontal position at or about 90 degrees from the front panel 18 when the straps are fully extended. Moreover, the panel 40 is of a suitably rigid construction, for example, by means of a foam insert or the like, to attain and maintain the horizontal position. To store the shade panel 40, fasteners 48, such as Velcro®, buttons, snaps or magnets, are provided on interfacing surfaces of the panels 40 and 18 so that the panel 40 is held relatively flat against front panel 18. It is understood that the shade panel may assume other configurations, including retractable structures, that can operate between a deployed position and a stored position.

According to one embodiment of the invention, the opening 30 receiving the display screen 32 includes a tinted panel (not shown) that rests over the display screen when received through the opening. The tinted panel, which may be removably affixed to the backpack, is configured to allow the image display device to be hidden from a viewer during an inactive state, and allow the image device to be shown to the viewer when it is activated to transmit images.

When activated to transmit images, the image display device 14 displays still or dynamic images provided by the various image sources 72-78. For example, the digital camera 72 may capture and provide video signals of still images, the video cassette reader 74 and DVD reader 76 may read and provide prerecorded video signals of dynamic images, and the video camera 78 may capture and/or provide live, real-time video signals of still or dynamic images.

According to one embodiment of the invention, the video backpack system 10 is used as a marketeering tool, leveraging the ability of a wearer of the backpack to infiltrate and maneuver him or herself in crowded areas. In this regard, the user wears the backpack 12 in a conventional manner with the back panel 16 resting against the user's back while the front panel 18 is exposed for viewing by others. The user then provides commands to the control unit 20 via either the control buttons 36 or the user input device 91, which may be a hand-held wireless device. The control unit 20 processes the commands and invokes a selected image source 72-78 to provide dynamic advertisement images for display on the image display device 14.

With the backpack 12 on the user's back activated to display dynamic advertisement images, the user moves into different target areas, allowing the backpack to become a marketing tool that is mobile and travels with the user. The backpack 12 is especially useful in infiltrating crowds or other areas where the placement or entry of billboards or other advertisement devices would be cumbersome or prohibited. For example, the backpack 12 may be used to advertise from many different locations and paths a particular booth during a trade show or a particular store within a mall.

According to one embodiment of the invention, the backpack 12 may also be used as a functional item that, in addition to allowing transportation of goods, also provides to the user entertainment, education, and information. In this regard, the backpack 12 is placed on the user's lap or on a surface in front of the user with the display screen 32 facing the user. The user then manipulates the control buttons 36 or the user input device 91 to select one of the various image sources 72-74 and cause it to provide images in accordance with the user's selection. Such a use may be especially convenient during long plane, bus, or train ride since the user may invoke the DVD reader to watch a movie or other types of entertainment shows.

The backpack 12, according to a further embodiment of the invention, may also be used as a novelty item. For example, images displayed on the display device 14 may be selected by the user based on the user's outfit, mood, or occasion. For example, bright, cheery images with an appropriate color scheme may be selected to complement a spring, or casual outfit. The image display 14 may also be used to readily share with others images of favorite people, animals, locations, or scenes. Such images may be prerecorded on a DVD, CD, cassette, or the like.

Alternatively, the video camera 78 or digital camera may be used to capture live, dynamic or still images for immediate display on the image display device 14. The digital or video camera 72, 78, along with their associated control buttons may be incorporated, for example, onto the shoulder straps 28 of the backpack 28 via clips or other types of fasteners. The images captured by the camera and displayed on the image display device 14 may then be printed via the printer 92 upon the transmission of appropriate commands to the control unit 20.

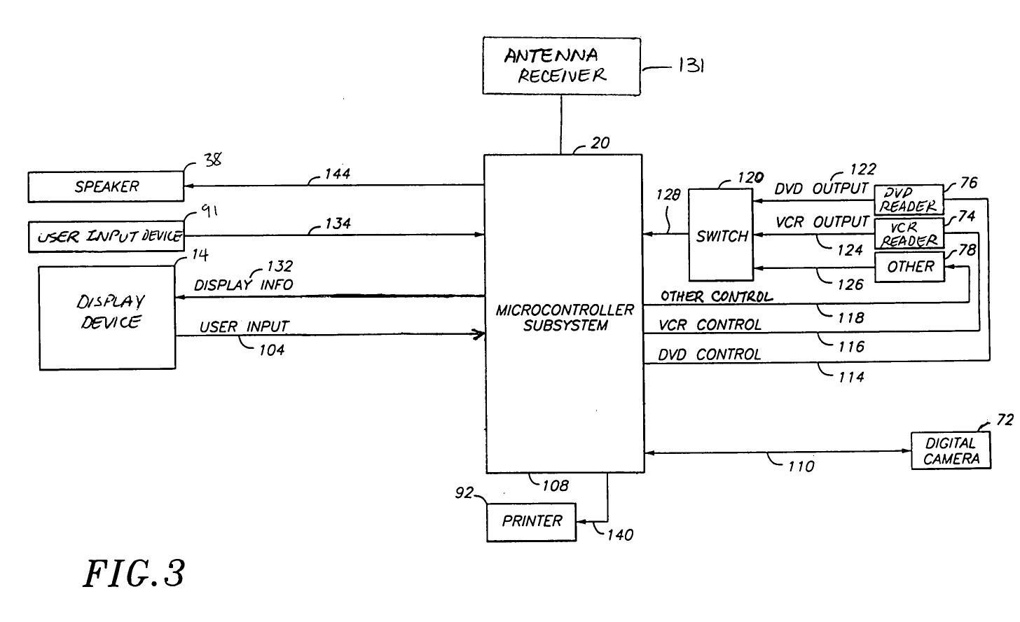

FIG. 3 is a block electrical circuit diagram of the video backpack system 10 according to one embodiment of the invention. The image display device 14 is coupled to the control unit 20 which is also referred to as a microcontroller subsystem 108. The image display device 14 provides to the microcontroller subsystem 108 user input signals via connection 104. User input signals from the user input device 91 may also be provided via connection 144.

The microcontroller subsystem 108 communicates with one or more of the plurality of video image sources such as, for example, the digital camera 72 via connection 110, the DVD reader 76 via connection 114, with VCR reader 74 via connection 116, and any other video image source including the video camera recorder 78 via connection 118.

Upon receiving the user input signals, the microcontroller 108 is adapted to activate and control any selected of the video image sources and receive the output video image signals therefrom. The microcontroller 108 communicates, controls, and receives output video image signals from the digital camera 72 via the connection 110, from the DVD reader 76 via connection 122, from the VCR reader 74 via connection 124, and/or from any other video image source 78 via connection 126. According to one embodiment of the invention, the system 10 may provide a switch 120 for selecting from output video image signals transmitted from a plurality of image source devices and relaying the signals from a selected device to the microcontroller 108 via connection 128.

In receipt of the output image signals, the microcontroller 108 sends the signals to the image display device 14 via connection 132. Any audio signals from the DVD reader 76, VCR reader 74 or other image source 78 are also sent along connections 122, 124, 126 and 128, respectively. The audio signals are processed by the microcontroller subsystem 108 and sent to the speakers 38 along connection 144.

The microcontroller subsystem is further adapted to activate and control the printer 92 via connection 140. In this regard, the microcontroller subsystem 108 is configured to output to the printer 92 images from any of the video image sources or information stored in the microcontroller subsystem 108.

According to one embodiment of the invention, the backpack 12 further includes an antenna and/or related infrared (IR) or radio frequency (RF) receiver circuitry 131 for wirelessly controlling the microcontroller subsystem to display images on the display device 14.

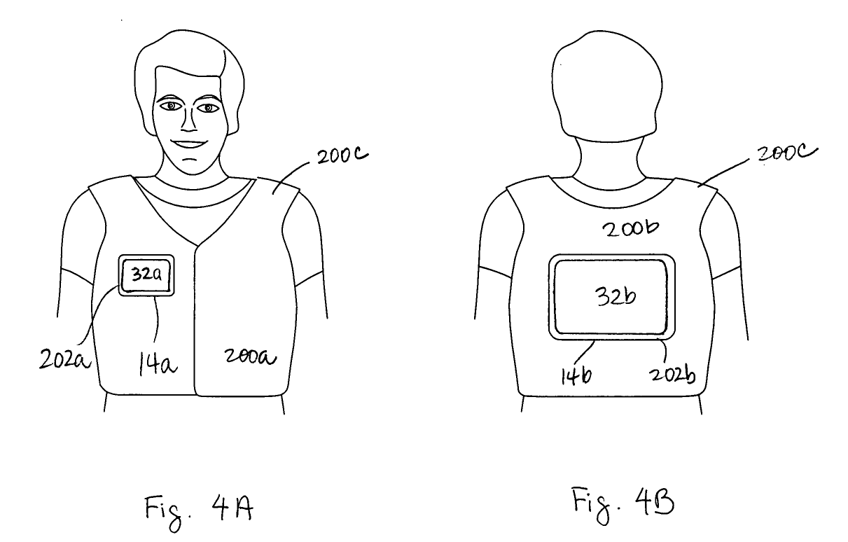

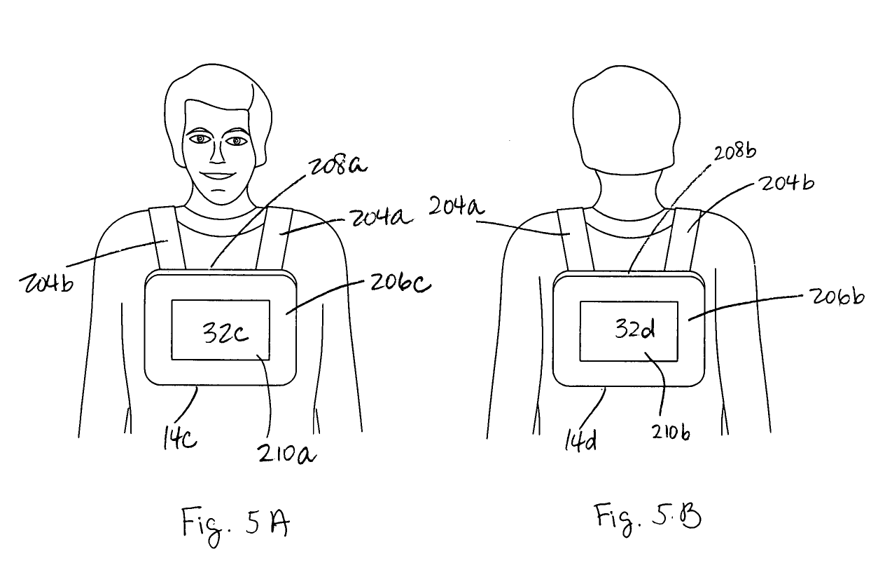

Referring to FIGS. 4A-5B, the system 10 may be configured as another wearable gear instead of a backpack. For example, as illustrated in FIGS. 4A-4B, the system may be configured as a garment, such as, for example, a vest, jacket, coat, or the like, that may be worn by a user of the system. According to the embodiment illustrated in FIG. 4A, the garment includes a front portion 200a, a back portion 200b, and a shoulder portion 200c. The front portion 200 rests over at least a portion of the wearer's chest, the back portion 200b rests over at least a portion of the wearer's back, and the shoulder portion 200c rests over the wearer's shoulders, supporting the garment on the wearer.

The front portion 200a includes an opening 202a that receives a display screen 32a of a display device 14a integrated with the garment. The garment may also include an opening 202b on the back portion 200b for receiving a display screen 32b of display device 14b that is also integrated with the garment. Display device 14b may be provided in lieu or in addition to display device 14a. Other components of the system such as, for example, the control unit 20, DVD reader 76, and the like, may be integrated into other portions of the garment.

According to another embodiment of the invention, the garment incorporating the system may be a “sandwich-board” garment that includes a pair of shoulder straps 204a, 204b making up a shoulder portion of the garment, a front casing 206a making up a front portion of the garment, and a back casing 206b making up a back portion of the garment. The shoulder straps 204a, 204b are fixedly or releasably coupled to the front and back casings 206a, 206b via any conventional fastening mechanism, such as, for example, snaps.

The front and/or back casing 206a, 206b includes an opening 208a, 208b on either a top, bottom, or body-contacting portion of the casing, and receives the display device 14c, 14d. A non-body contacting portion of the casing includes a second opening 210a, 210b receiving a display screen 32c, 32d of the display device 14c, 14d. During usage, the user hangs the straps 204a, 204b over the user's shoulders, and wears the display device 14c, 14d over the user's chest and/or back, exposing the display screen 32c, 32d to a non-wearer of the sandwich-board garment.

The garments in FIGS. 4A-5B may be used as a functional item for entertaining, informing or educating a viewer via images displayed on the image display device. The garment may also be used as a novelty item by controlling the images displayed on the display screens and changing the appearance of the garment. The garment may in addition be used as a marketing item to display advertisement messages on the display screens. Again, in accordance with the present invention, the user wearing the garment can walk, jog or even ride a bicycle, a motorcycle or the like to render himself and the garment mobile.

It is understood by one of ordinary skill in the art that the various components described hereinabove may assume different configurations all accomplishing the same desirable result. It is also understood by one of ordinary skill in the art that the configurations and dimensions of various components may be altered and modified as desirable. In that regard, various alternative techniques and configures may be employed departing from those disclosed and suggested herein. For example, although the present embodiment is described in terms of backpacks, a person of skill in the art should recognize that other types of bags may be utilized instead of backpacks, such as, for example, purses, handbags, totes, duffle bags, briefcases, satchels, and the like, which need not be carried on the backs and/or shoulders of the user, but can be carried, pushed, pulled, or otherwise transported by other parts of the user's body.

Consequently, it is to be understood that the scope hereof should be determined in accordance with the claims as set forth below.

1. An image display system comprising:
a wearable gear having an integrated electronic display screen;
at least one video image source adapted to provide an image on the display screen; and
a control unit coupled to the video image source and the display screen, the control unit controlling the video image source to transmit to the display screen signals representative of the image.

2. The display system of claim 1, wherein the video image source includes a video disc reader.

3. The display system of claim 1, wherein the video image source includes a camera.

4. The display system of claim 1 further comprising a printer.

5. The display system of claim 1, wherein the wearable gear is a backpack.

6. The display system of claim 1, wherein the wearable gear is a garment.

7. A portable bag comprising:
a body contact side including at least one shoulder strap adapted to the hung from a user's shoulder;
a non-body contact side with an opening thereon receiving an electronic display screen;
at least one video image source adapted to provide an image on the display screen; and
a control unit coupled to the video image source and the display screen, the control unit controlling the video image source to transmit to the display screen signals representative of the image.

8. The bag of claim 7, wherein the video image source includes a video disc reader.

9. The bag of claim 7, wherein the video image source includes a camera.

10. A garment comprising:
a front portion resting over at least a portion of a wearer's chest;
a back portion resting over at least a portion of a wearer's back;
a shoulder portion resting over a wearer's shoulders;
an opening on one of the front and back portions, the opening receiving an electronic display screen;
at least one video image source adapted to provide an image on the display screen; and
a control unit coupled to the video image source and the display screen, the control unit controlling the video image source to transmit to the display screen signals representative of the image.

11. The garment of claim 10, wherein the video image source includes a video disc reader.

12. The garment of claim 10, wherein the video image source includes a camera.

13. A method for advertising comprising:
utilizing the portable bag as described in claim 7 to display an advertisement message on the electronic display screen.

14. A method for altering the appearance of the portable bag of claim 7 comprising:
controlling the video image source to switch an image displayed on the electronic display screen from a first image to a second image.

15. A method for advertising comprising:
utilizing the garment as described in claim 10 to display an advertisement message on the electronic display screen.

16. A method for altering the appearance of the garment of claim 10 comprising:
controlling the video image source to switch an image displayed on the electronic display screen from a first image to a second image.

17. A method for displaying images comprising:
providing a wearable gear having an integrated electronic display screen, the display screen being coupled to a control unit communicating with a video image source;
receiving from the video image source signals representative of a first image; and
displaying the image on the display screen.

18. The method of claim 17, wherein the video image source includes a video disc reader.

19. The method of claim 17, wherein the video image source includes a camera.

20. The method of claim 17 further comprising:
providing a printer coupled to the display screen; and
printing the image displayed on the display screen via the printer.

21. The method of claim 17, wherein the wearable gear is a backpack.

22. The method of claim 17, wherein the wearable gear is a garment.

23. A method for advertising comprising:
providing a portable bag having an integrated electronic display screen, the display screen being coupled to a control unit communicating with a video image source;
receiving from the video image source signals representative of an advertisement message;
displaying the advertisement message on the integrated electronic display screen; and
transporting the portable bag so as to allow the display screen to be viewable by a non-user of the bag.

24. The method of claim 23, wherein the video image source includes a video disc reader.

25. The method of claim 23, wherein the video image source includes a camera.

26. The method of claim 23 further comprising:
providing a printer coupled to the display screen; and
printing the image displayed on the display screen via the printer.

27. A method for advertising comprising:
providing a garment having an integrated electronic display screen, the display screen being coupled to a control unit communicating with a video image source;
receiving from the video image source signals representative of an advertisement message;
displaying the advertisement message on the integrated display screen; and
wearing the garment so as to allow the display screen to be viewable by a non-wearer of the garment.

28. The method of claim 27, wherein the video image source includes a video disc reader.

29. The method of claim 27, wherein the video image source includes a camera.

30. The method of claim 27 further comprising:
providing a printer coupled to the display screen; and
printing the image displayed on the display screen via the printer.
